(19) United States
(12) Patent Application Publication
(10) Pub. No.: US 2009/0269508 A1
(43) Pub. Date: Oct. 29, 2009

(54) Method of manufacturing a magnetic recording medium

(75) Inventors: Hiromi Ono, Yamanashi (JP); Minoru Yamagishi, Yamanashi (JP)

Correspondence Address: RABIN & Berdo, PC, 1101 14TH STREET, NW, SUITE 500, WASHINGTON, DC, 20005, US

(73) Assignee: Fuji Electronic Device Technology Co., Ltd., Tokyo (JP)

(21) Appl. No.: 12/385,677

(22) Filed: Apr. 15, 2009

(30) Foreign Application Priority Data
Apr. 24, 2008 (JP) PA 2008-114303

(51) Int. Cl. B01J 19/08; B05D 3/00

(52) U.S. Cl. 427/535; 427/532

(57) ABSTRACT

A method for manufacturing a magnetic recording medium, which includes providing a substrate for the magnetic recording medium, electrically charging the substrate with a positive voltage, and then forming the thin film layers on the substrate. The thin film layers includes at least a metallic underlayer, a magnetic recording layer, a protective layer composed of at least carbon, and a lubricant layer, formed in this order on the substrate. The method enables manufacture of a magnetic recording medium that exhibits high reliability and good read/write performance.

### CROSS-REFERENCE TO RELATED APPLICATION

This application is based on, and claims the priority benefits of Japanese Patent Application No. 2008-114303, filed on Apr. 24, 2008, the contents of which are incorporated herein by reference.

### BACKGROUND OF THE INVENTION

1. Field of the Invention

The present invention relates to manufacturing magnetic recording media for recording devices of information processing devices such as computers.

2. Description of the Related Art

Demands for high-density recording by the recording devices disposed in information processing devices are increasing each year. Advances in magnetic recording devices are being made to cope with the demands for the high-density recording.

A magnetic recording device is composed of parts such as a magnetic head for reading/writing magnetic signals, a magnetic recording medium for recording magnetic signals, and a spindle motor for rotating the magnetic recording medium. The magnetic recording medium rotates at a high speed, which may range from several to over ten thousand revolutions per minute (rpm) when reading/writing magnetic signals.

During the reading/writing, the magnetic head flies at a certain distance from the surface of the magnetic recording medium. The height at which magnetic heads fly above the magnetic recording medium has been decreasing as the recording density has increased. In recent magnetic recording devices with a recording density greater than 60 G bits/in², the flying height of the magnetic heads has been reduced to as low as about 10 nm.

In some magnetic heads installed in up-to-date magnetic recording devices with a recording density exceeding 90 G bits /in², a mechanism is employed in which a magnetic pole for generating and reading magnetic signals of the magnetic head protrudes from a base of the magnetic head, and the read/write of the magnetic signal is performed in the close vicinity of the magnetic recording medium. In this mechanism, the distance between the tip of the magnetic pole and the surface of the magnetic recording medium sometimes is close to 4 nm or less. Accordingly, the surface of the magnetic recording medium needs to have a precisely controlled configuration, and, more importantly, must avoid adhesion of minute foreign matter.

Since the length of one recording bit on the magnetic recording media has been reduced to a minute value of less than 30 nm, even extremely small foreign matter may cause the loss of a magnetic recording bit. Accordingly, the process of manufacturing a conventional magnetic recording medium usually includes a step of removing foreign matter adhered to the surface of the magnetic recording medium.

An ordinary magnetic recording medium typically has an underlayer, several metallic thin films including a magnetic recording layer, and a protective layer of carbon for protecting the magnetic recording layer. These layers are formed sequentially on a non-magnetic substrate that is of a disk shape and is made of plated aluminum alloy or glass. These layers are generally formed by a vacuum deposition method such as sputtering or chemical vapor deposition (CVD).

Before and after each deposition step of the vacuum deposition method, steps are taken to remove the foreign matter adhered to the surface of the magnetic recording medium. Before a deposition step, for example, a wet process is implemented to remove organic substances and foreign matter of a particle shape. After a deposition step, a process is generally implemented, for example using a polishing tape, to remove particles of carbon that became adhered to the uppermost surface of the magnetic recording medium during the deposition step.

Japanese Unexamined Patent Application (Publication No. 2006-209937) discloses a method of manufacturing a magnetic recording medium, which includes forming a magnetic recording layer on at least one side of the surfaces of a flexible polymer substrate (such as a flexible disk or a magnetic tape), wherein static electricity on the flexible polymer substrate is neutralized in a non-contact condition before the magnetic recording layer is formed.

Most magnetic recording devices produced to date have been used in stationary apparatuses such as desktop type personal computers and servers. In those apparatuses, magnetic recording media with a plated aluminum substrate have generally been employed to reduce costs. Meanwhile, the number of magnetic recording devices used in apparatuses such as notebook-type personal computers, portable music players, and car navigation systems is growing. In those devices, which are subjected to vibration, a magnetic recording medium using a glass substrate exhibiting good anti-shock performance is employed. The demand for such magnetic recording media is believed to be expanding every year.

A vacuum deposition device used in a film deposition process during production of a magnetic recording medium generally contains, although in a very small amount, contaminant particles that have been generated in the deposition process. An insulating substrate such as a glass substrate is generally charged with a negative voltage. Hence, contaminant particles tend to adhere to the insulating substrate. The contaminant particles in the vacuum chamber adhere to the surface of an insulating substrate that is introduced into the vacuum chamber. The previously mentioned metallic thin films and the carbon thin film are thus formed on these particles. If a spot of particle adhesion is a protrusion with a height more than the flying height of the magnetic head, the particle will obstruct the flight of the magnetic head, and thus degrade the reliability of the magnetic recording device.

Some contaminant particles may be detached in a cleaning step using a polishing tape implemented after the deposition step. In that case, however, a portion of the magnetic recording layer on the particle is simultaneously detached, which causes a drop-off of a recording bit and the degradation of the read/write performance.

### SUMMARY OF THE INVENTION

It is therefore an objective of the present invention to provide a method of manufacturing a magnetic recording medium using an insulating substrate, which prevents contaminant particles from adhering to the insulating substrate before the film deposition and that enables the magnetic recording medium to be manufactured with high reliability and good read/write performance.

In order to accomplish this objective, a magnetic recording medium is manufactured with at least a metallic underlayer, a magnetic recording layer, a protective layer composed of at least carbon, and a lubricant layer, which layer are formed sequentially on a non-magnetic substrate. The non-magnetic substrate has an insulator, and is electrically charged with a positive voltage before a layer is formed in contact with the non-magnetic substrate.

The method of the invention suppresses the number of contaminant particles that will adhere to the surface of the non-magnetic substrate during a period after introducing the substrate into a film deposition apparatus and before the formation of thin film layers.

### BRIEF DESCRIPTION OF THE DRAWINGS

FIG. 1 is a schematic figure showing the construction of a magnetic recording medium;

FIG. 2 is a chart showing a construction of an apparatus used in the embodiments; and

FIG. 3 is a table showing different positive voltages for glass substrates in three examples.

### DETAILED DESCRIPTION OF THE INVENTION

The invention will now be described in more detail by way of example with reference to the embodiments shown in the accompanying figures. It should be kept in mind that the following described embodiments are presented only by way of example and should not be construed as limiting the inventive concept to any particular physical configuration. Further, if used and unless otherwise stated, the terms “upper,” “lower,” “front,” “back,” “over,” “under,” and similar such terms are not to be construed as limiting the invention to a particular orientation. Instead, these terms are used only to express relative positions.

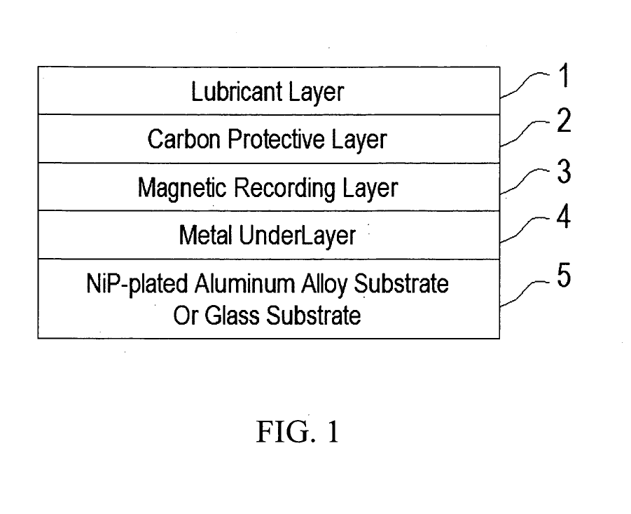

FIG. 1 schematically shows a structure of a magnetic recording medium manufactured in accordance with the invention. The magnetic recording medium includes at least a metallic underlayer 4, a magnetic recording layer 3, a protective layer composed of at least carbon 2, and a lubricant layer 1, which are formed in this order on a non-magnetic substrate 5. It should be noted that each of the metallic underlayer, the magnetic recording layer, the protective layer composed of at least carbon, and the lubricant layer hereafter can be any respective layer employed in ordinary magnetic recording media, and is not limited to any special layer.

In the manufacturing method of the present invention, a non-magnetic substrate made of an insulator is electrically charged with a positive voltage before thin film layers (such as the metallic underlayer, the magnetic recording layer, the carbon protective layer, and the lubricant layer) are formed on the non-magnetic substrate 5. After depositing the first thin film 4, the subsequent layers 1-3 are formed in the apparatus with a controlled environment, which prevents excessive adhesion of contaminant particles.

Plated aluminum alloy substrates and glass substrates are widely used for non-magnetic substrates 5 in manufacturing magnetic recording media. In a conventional method, the non-magnetic substrate made of an insulator material, such as glass, is in a negatively charged electrostatic condition. In contrast, contaminant particles floating in a space are positively charged. Therefore, the conventional non-magnetic substrate is liable actively to attract the contaminant particles floating in the space due to the electrostatic conditions. Traditional methods, such as electrostatically neutralizing the non-magnetic substrate, as disclosed in Japanese Unexamined Patent Application (Publication No. 2006-209937), while suppressing active adhesion of the contaminant particles floating in a space, does not prevent the adhesion due to collisions of the contaminant particles floating in the space against the substrate surface.

In the present invention, the non-magnetic substrate is electrically charged with a positive voltage before the thin film layers 1-4 are formed on the non-magnetic substrate 5. Therefore, the contaminant particles, located in a space above the substrate and floating toward a collision with the substrate, are repelled by an electrostatic force. Thus, the adhesion of contaminant particles is more actively suppressed.

Electrically charging the non-magnetic substrate can be performed by, for example, RF plasma processing. The minimum RF output power for RF plasma processing is an output power sufficient to reverse the charged voltage of the non-magnetic substrate from a negative value to a positive value. The minimum output power varies depending on the type of the non-magnetic substrate and the charge conditions, and preferably the output power has a value higher than 60 W.

An elevated RF output power in the RF plasma processing produces an etching effect on the substrate surface, which can be expected to have an effect to remove contaminant particles. However, the etching action changes the configuration of the substrate surface. Because the substrate surface is designed in an optimum configuration corresponding to the surface configuration of the magnetic head, a change in the configuration of the substrate surface is undesirable. Therefore, an upper limit of the RF output power is preferably below 2,500 W, and varies with the type of the non-magnetic substrate and the charge conditions.

The present invention will be described in more detail with reference to the following three examples.

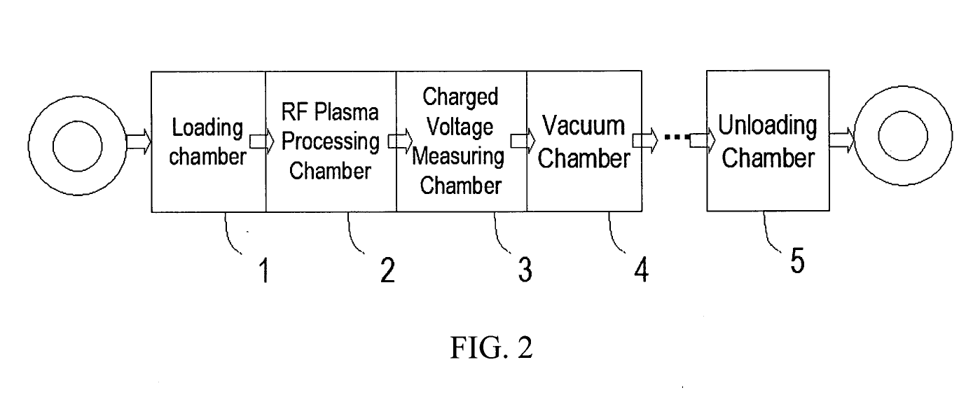

FIG. 2 shows a construction of the apparatus used in the examples. The apparatus used was a 200 Lean® of Intevac, Inc. that includes a number of vacuum chambers connected together. First, a glass substrate, after a wet cleaning process is performed, is transported from a loading chamber 1 to the vacuum apparatus. The substrate is a glass substrate for magnetic recording media made by Hoya Corporation, and has an outer diameter of 65 mm, an inner diameter of 20 mm, and a thickness of 0.635 mm. Then, the substrate is transported to an RF plasma-processing chamber 2 for RF plasma processing. The RF plasma is generated by introducing argon gas into the RF plasma processing chamber 2 and applying a predetermined voltage to the substrate. The argon gas pressure in the RF plasma processing is 10 mTorr and the time for the RF plasma processing is 1.8 sec. In the three examples 1, 2 and 3, the value of RF output power in the RF plasma processing is respectively 100 W, 200 W and 300 W.

Then, the substrate is transported to a charged voltage measuring chamber 3 to measure the voltage to which the substrate has been charged. Measurements of the substrate voltage are carried out by a Model 542 Electrostatic Voltmeter, a product of Trek, Inc. In order to confirm the effect of suppressing adhesion of contaminant particles, the substrate, after the RF plasma processing and the voltage measurement, is passed through a number of vacuum chambers 4 that are intentionally made to generate contaminant particles. Then, the substrate is removed from an unloading chamber 5.

After that, the number of contaminant particles adhered to the substrate surface is measured. The measurement of the number of particles is carried out using an OSA (Optical Surface Analyzer), which is a product of KLA-Tencor Corporation.

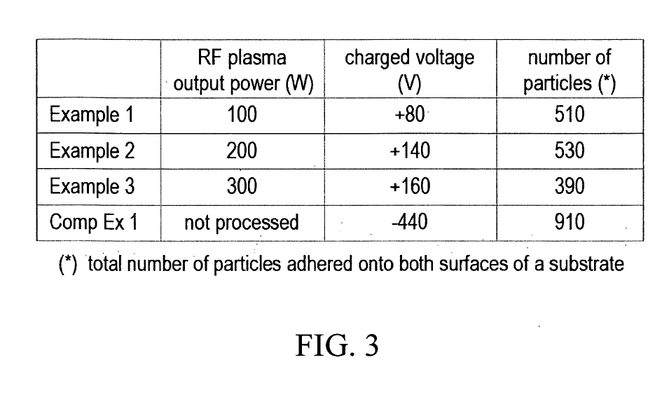

The table in FIG. 3 shows positive voltages for every glass substrate of the three examples, while a negative voltage for the glass substrate is shown in a Comparative Example 1. The numbers of particles on the glass substrates after transportation through the vacuum chambers are reduced by the RF plasma treatment that charges the substrates to a positive voltage, and are further decreased when the substrate voltage is more than 140 V in the RF plasma processing. This demonstrates that the RF plasma processing reverses the voltage charged on the glass substrate from a negative value to a positive value, and that adhesion of contaminant particles in a vacuum apparatus is suppressed.

An excessively high RF output power in the RF plasma processing will produce an etching effect on the substrate surface, and change the configuration of the substrate surface. In the three examples, it has been confirmed that no change in the configurations of the substrate surface before and after the RF plasma processing was observed using an AFM (atomic force microscope). It ensures that the effect of eliminating contaminant particles is not from an etching action, but rather from controlling a voltage to which the substrate is charged.

It should be understood, that the invention is not necessarily limited to the specific process, arrangement, materials and components shown and described above, but may be susceptible to numerous variations within the scope of the invention.

What is claimed is:

1. A method of manufacturing a magnetic recording medium, comprising:
providing a substrate for the magnetic recording medium;
electrically charging the substrate with a positive voltage; and
after the electrically charging, forming thin film layers on the substrate.

2. The method of manufacturing a magnetic recording medium of claim 1, wherein the electrically charging includes exposing the substrate to a RF plasma processing without changing a surface configuration of the substrate.

3. The method of manufacturing a magnetic recording medium of claim 1, wherein the forming thin film layers include forming a metallic underlayer, a magnetic recording layer, a carbon protective layer, and a lubricant layer.

4. The method of manufacturing a magnetic recording medium of claim 1, wherein the forming thin film layers includes forming sequentially the metallic underlayer, the magnetic recording layer, the carbon protective layer, and the lubricant layer, on the substrate.

5. The method of manufacturing a magnetic recording medium of claim 1, wherein the substrate is a non-magnetic substrate.

6. The method of manufacturing a magnetic recording medium of claim 5, wherein the non-magnetic substrate is composed of an insulator.

7. The method of manufacturing a magnetic recording medium of claim 5, wherein the non-magnetic substrate is one of a NiP-plated aluminum alloy substrate and a glass substrate.
